(19) United States
(12) Patent Application Publication
(10) Pub. No.: US 2010/0004989 A1
(43) Pub. Date: Jan. 7, 2010

(54) SYSTEMS, METHODS, APPARATUS AND COMPUTER PROGRAM PRODUCTS FOR INTERFACING PAYMENT SYSTEMS TO A NETWORK ASSOCIATED WITH A REFERRAL

(75) Inventors: David S. Bonalle, New Rochelle, NY (US); Aliya Bokhari Bethea, Los Angeles, CA (US); Deborah E. Cronen, New York, NY (US); Jennie M. Bartkowiak, Los Angeles, CA (US); David J. Knaut, Willowbrook, IL (US)

Correspondence Address: FITZPATRICK CELLA (AMEX), 1290 Avenue of the Americas, NEW YORK, NY, 10104-3800, US

(73) Assignee: American Express Travel Related Services Company, Inc., New York, NY (US)

(21) Appl. No.: 12/468,558

(22) Filed: May 19, 2009

Related U.S. Application Data
(60) Provisional application No. 61/054,598, filed on May 20, 2008.

(51) Int. Cl. G06Q 30/00; G06Q 20/00; G06F 17/30

(52) U.S. Cl. 705/14.16; 705/40; 707/3; 707/E17.014

(57) ABSTRACT

A network interface, including a referral receiver, a payment processor and a referral matching module. The referral receiver receives a referral presented to a user and the payment processor performs a transaction. In turn, the referral matching module matches the referral with the transaction and communicates the match to a network associated with the referral.

### CROSS REFERENCE TO RELATED APPLICATIONS

This application claims priority to, and the benefit of, U.S. Provisional Patent Application Ser. No. 61/054,598, filed May 20, 2008, which is hereby incorporated by reference in its entirety.

### FIELD

The present invention relates to network interfacing, and more particularly to sharing resources of multiple networks and providing linkages between independent network processes.

### BACKGROUND

Existing search engine and advertisement systems, such as general internet search engines, and publisher and advertisement networks, and the like, provide no way to facilitate, link or monetize the shop-to-purchase experience with payment systems because their respective networks are not integrated. Instead, typical search engine and advertisement systems provide results to users based solely on information they collect and store.

Typical search engines generate revenue based on various advertisement models including charging a merchant for presenting a user with advertisements based on a user search inquiry (referred to as a “search-to-click” model) or by charging the merchant if the user purchases a product found by and purchased through the search engine (referred to as “search-to-purchase” model), or a combination of both.

Attempts have been made to integrate the search-to-purchase experience by expanding beyond search capabilities into purchase and rewards. However, these business expansions have not created the seamless cycle which provides enhanced targeting with deep consumer data, an offline-online link, pay-for-purchase advertising and a rewards platform.

One technical challenge is to provide seamless integration of search-to-purchase activities using both the search engine system capabilities and the payment issuer/processor system capabilities to provide benefits to both online shoppers and merchants. Particularly, the technical challenge in integrating these two systems involves closing the loop on search and targeting capabilities with online and offline purchase data. Another technical challenge involves integrating a rewards platform with the search engine and issuer/payment systems to provide strong merchant and shopper relationships and e-wallet capabilities which all function together to drive search-to-purchase efficiency for all involved parties.

### BRIEF DESCRIPTION OF THE INVENTION

The present invention meets the above-identified needs by providing systems, methods, apparatus and computer program products for interfacing card payment systems to search engine systems.

In one aspect of the present invention, a card issuer is capable of providing both online and offline assets such as closed loop cardmember data, a rewards platform, a large and loyal shopper base, and strong merchant relationships. These assets, paired with search engine capability (e.g., from a partner) and an e-wallet build or other payment source, form the integrated solution which current industry players heretofore could not achieve due to a lack of key assets such as online/offline data and relationships, an integrated rewards platform, and more particularly due to the lack of an interface between such disjointed systems.

In another example aspect of the present invention, a network interface, including a referral receiver, a payment processor and a referral matching module are provided. The referral receiver receives a referral presented to a user and the payment processor performs a transaction. In turn, the referral matching module matches the referral with the transaction and communicates the match to a network associated with the referral.

In another embodiment there is provided a computer-readable medium having instructions, which when executed by a computer system, cause the computer system to receive a referral presented to a user, communicate data associated with a transaction to a payment processor, and match the referral with the transaction and communicate the match to a network associated with the referral.

In yet another embodiment, there is provided a method for interfacing, including receiving a referral presented to a user, communicating data associated with a transaction to a payment processor, and matching the referral with the transaction and communicate the match to a network associated with the referral.

Further features and advantages of the present invention as well as the structure and operation of various embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1 is a block diagram showing an example integration of both a search engine system and card payment system in accordance with an embodiment of the present invention.

FIG. 2 is an example enhanced targeting and search process flow in accordance with an embodiment of the present invention.

FIG. 3 is an example referral tracking process flow performed for local purchases in accordance with an embodiment of the present invention.

FIG. 4 is an example referral tracking process flow for online purchases in accordance with an embodiment of the present invention.

FIG. 5 illustrates an exemplary rewards enrollment process flow in accordance with an embodiment of the present invention.

FIG. 6 is a block diagram of an example interface unit for integrating a search engine system and a card payment system in accordance with an embodiment of the present invention.

### DESCRIPTION

The present invention is directed to a system, method and computer program product for interfacing card payment systems to search engine systems. While the present invention is described as interfacing card payment systems to search engines, it should be understood that this is for convenience only and is not intended to limit the application of the present invention. In fact, after reading the following description, it will be apparent to one skilled in the relevant art(s) how to implement the following invention in alternative embodiments that use different payment processing forms, such as electronic funds transfer, mobile payments, etc. Similarly, while the examples herein involve search engines, the same system, method and computer program products can be used to interface the payment processors with publisher and advertisement networks.

Generally, an integrated set of utilities are provided which strengthen the card issuers position online by making the online shopping experience easier, safer, and more rewarding for shoppers while delivering significant value to merchants. This is accomplished by providing components that enhance search and targeting by integrating the card issuer data; linking offline purchases to online targeting using local search capabilities with card issuer data; enhancing checkout for cardmembers which are linked to pay-for-purchase advertising for merchants; and by adding a rewards platform to online search and purchase systems.

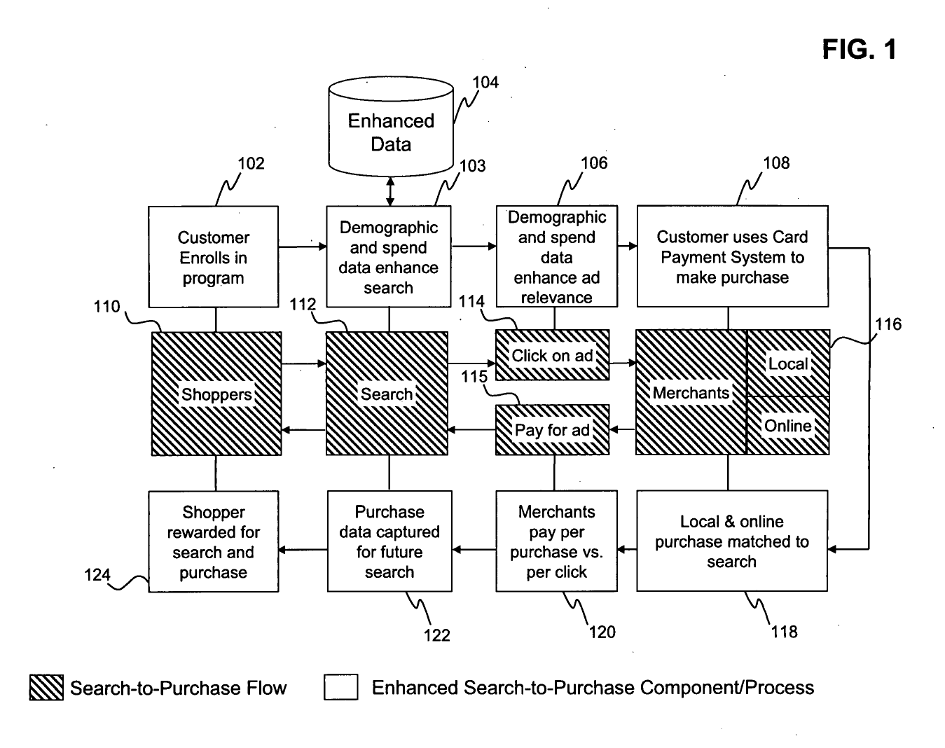

FIG. 1 is a block diagram showing an example integration of both a search engine system and a card payment system in a manner which provides enhanced search-to-purchase results, referral reporting, loyalty rewards, and merchant reconciliation. Block 102 depicts a customer enrollment procedure which enrolls customers in a program that provides enhanced search results and advertising using information provided by a card issuer and search engine provider (hereinafter the program is also referred to as the “enhanced search program”). Enrolling in this program gives the search engine and a card issuer system permission to link their networks and resources to provide an enhanced search for the user as well as provide matching of online and offline purchases made with the card issuer's transaction card with referrals provided through a search engine.

Block 110 represents shoppers interacting with a search engine 112. As shown, search engine 112 is linked to the card issuer system's search enhancement procedure 103 which provides demographic and spend data to the search engine based on either the particular shopper or the shopper's search inquiry. The card issuer search enhancement procedure 112 receives information from an enhancement database 104.

Block 106 depicts a card issuer advertisement procedure, which provides demographic and spend data enhanced advertisements to the consumer through the search engine. This data can be received from the enhancement database (link not shown) or from another, separate database. If a user selects an advertisement (block 114) presented by the search engine 112, then the user is taken to a merchant website (block 116). After receiving the referral through the search engine 112, a merchant website may be entered locally (e.g., a consumer may log off the search engine and physically go to the merchant's physical store) or the user may continue to shop online on the merchant's webpage. Alternatively, a user may enter a merchant's website, log off the website, and later go directly to the merchant's website without first logging onto the search engine. In all three cases, the consumer has reached the merchants webpage or physical store because of the referral provided by the search engine.

Taking the shopping experience one step further, a user may make a purchase with the card of the card issuer through the search engine or directly from the merchant's website. In addition, the user may, for example, study an online catalog, then log off, and later log on to purchase a referred item either through the search engine or directly by logging onto the merchant's website. Again, the consumer has purchased the item because of the referral provided by the search engine.

Block 118 depicts a purchase matching procedure which provides a match between referrals presented to a consumer during a search and a purchase made from the advertised merchant using the card issuer's transaction card, where the purchase was made either online or locally as described above. As will be explained in more detail below, the card issuer keeps track of referrals presented by the search engine by processing and maintaining referral reports it receives from the search engine network. Should a user (e.g., shopper) purchase a product that has been referred through the search engine, the card issuer system can match the referral with the purchase. The search-to-purchase match information is then provided back to the search engine.

Block 115 illustrates a procedure for processing payments made by merchants to the search engine to pay for each advertisement the search engine has presented to a consumer, the terms and conditions for payments being dependent on the agreement between each merchant and the search engine provider. Block 120 depicts a procedure in which payments per purchase are made by the merchants based on the referral matching provided by the card issuer (block 118) that results in a purchase transaction handled by the card issuer's payment processor. Purchase information is also passed to a purchase data capture engine 122 to collect information for improving future searches. Also included is a loyalty reward procedure 124 which provides shoppers 110 with rewards for making purchases or selecting advertisements using the enhanced search program.

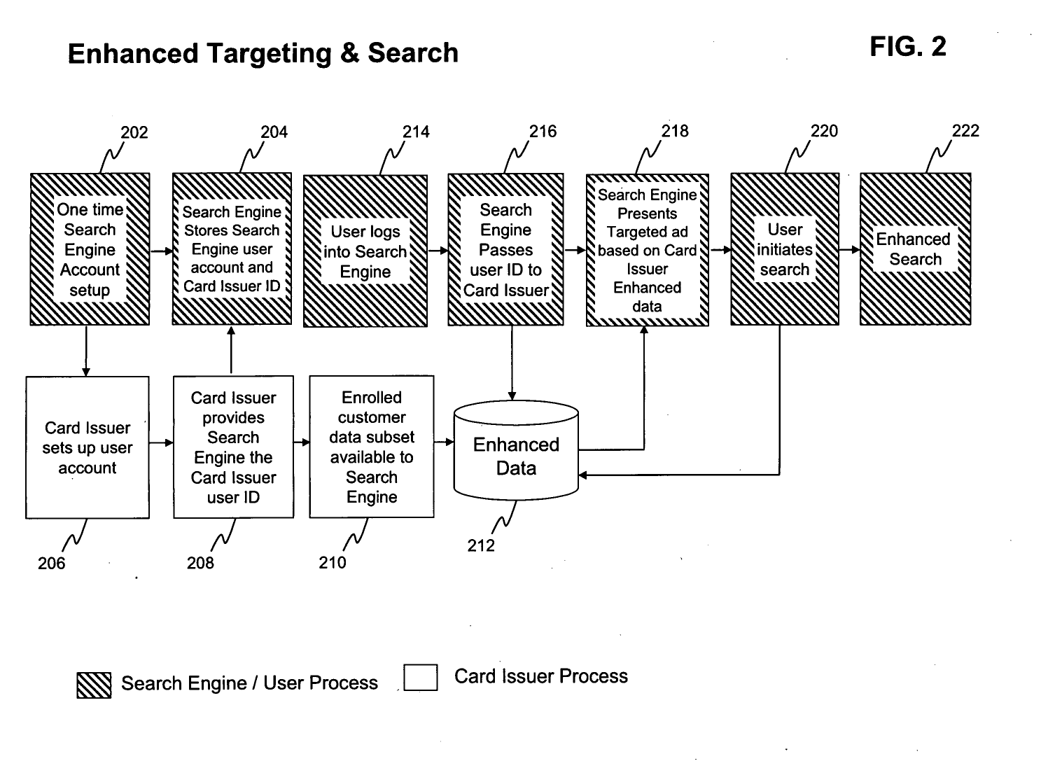

FIG. 2 is a more detailed description of the enhanced targeting and search process flow. Initially, at block 202, an account is setup to enroll the user with the search engine provider services. At block 206, the card issuer also sets up a user account which results in the generation of a card holder user identifier (“ID”). The card issuer, in turn, provides the search engine provider with the card holder user ID, as shown at block 208. At block 204, the search engine provider stores the user account information associated with the search engine provider's account as well as the card issuer ID. When the user sets up an account and enrolls in the enhanced search program, a data subset collected from the user is stored in an enhanced database 212 (block 210) or other separate database and made available to the search engine.

At block 214, a user initiates an enhanced search by logging into the search engine. The search engine uses the user ID to obtain enhanced data such as advertisements or user specific information from the card issuer enhanced database 212 to assist the search engine in providing referrals and more relevant search results, as shown in block 216. In turn, at block 218 the user is presented with targeted advertisements based on the information received from the card issuer's enhanced database 212, as shown in 218. Optionally, the search engine may present targeted advertisements based on information stored in its own database. The user may then initiate a search as shown at block 220, which causes enhanced search results to be returned as shown at block 222. User search inquiries may also be stored in the enhanced database 212. It should be understood that block 218 may be executed after block 220, or at other times in the process flow and is not limited to presenting targeted advertisements before performing a search.

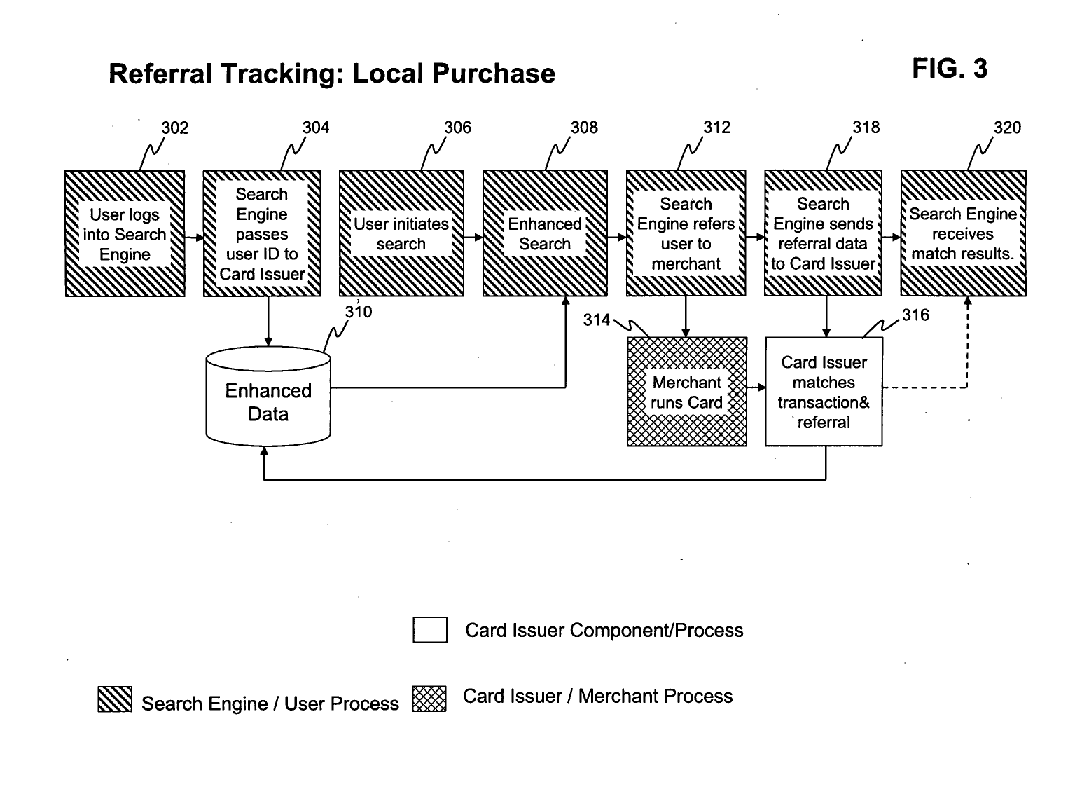

FIG. 3 is a block diagram illustrating how referral tracking is performed for local purchases. At block 302, a user logs into the search engine which, in turn, passes the user ID to the card issuer enhanced database 310, as shown in block 304.

It should be understood that logging on using the above-described user ID is just one example of an identification mechanism. Other identification mechanisms can be used and still be within the scope of the present invention. For example, cookies may be implemented to provide users access without requiring user log-in, where the search engine and the payment processor share the same cookie. When the cookie is recognized by, for example, the search engine, the search engine serves an advertisement in response.

A user may then initiate a search inquiry at block 306, to receive enhanced search results based on information from the card issuer's enhanced data database 310, as shown in block 308. The search engine refers the user to a merchant as shown in block 312 and sends the referral data to the card issuer as shown in block 318. The card issuer stores this referral information.

If the user makes a purchase based on the referral, the merchant processes the payment. Preferably, the payment processing is performed by both the merchant's payment system in combination with the card issuer's payment system or solely through the card issuer's payment system. Having stored the search engine referral, the card issuer matches the transaction and the referral (block 316), and sends the match results to the search engine as shown in block 320. Upon receipt of the match results (block 320) the search engine is now able to charge the merchant for local purchases based on referrals made through the search engine.

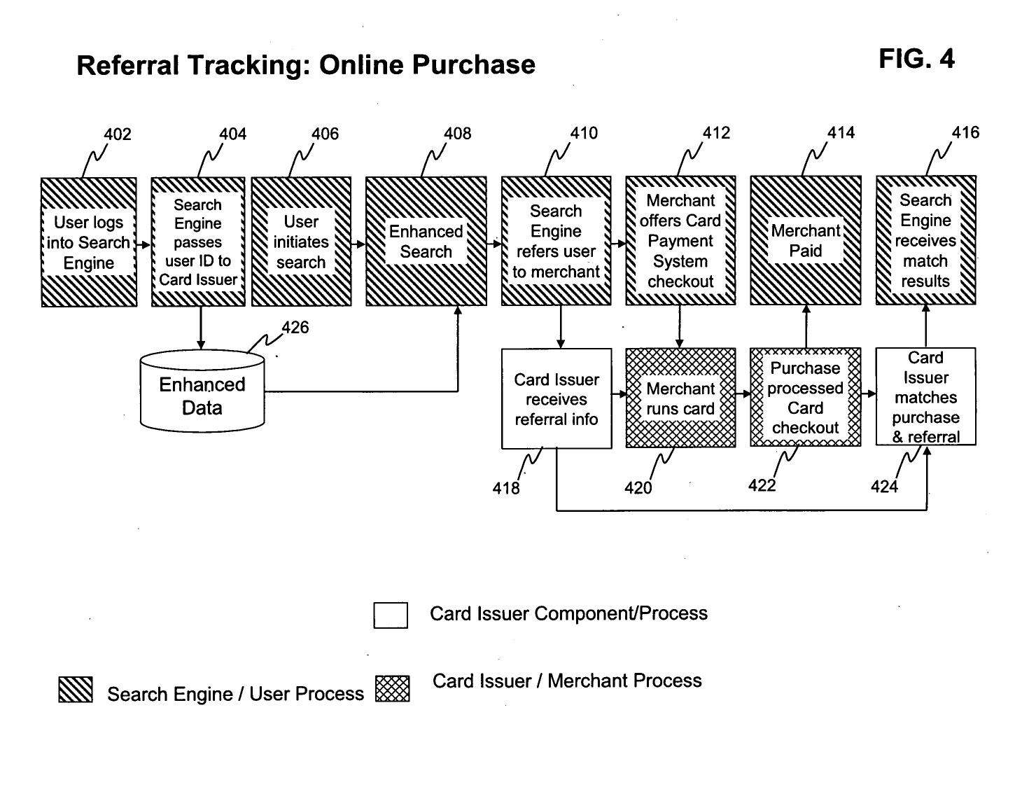

FIG. 4 is a block diagram illustrating how referral tracking is performed for online purchases. The execution of the referral tracking procedure is independent of existing checkout/payment system hardware and software. Thus, from a merchant's perspective no additional installation is required. At block 402, a user logs into the search engine which passes the user ID to the card issuer to be stored in an enhanced database 426, as shown in block 404. A user may then initiate a search inquiry at block 406, and in return receives enhanced search results based on information received from the enhanced database 426, as shown in block 408. The search engine refers the user to a merchant as shown in block 410 and in block 418 sends the card issuer the referral information for later processing.

If the shopper elects to purchase an item offered by the merchant, the option of making the purchase using a card payment system checkout is offered to the user, as shown in block 412. If this form of payment is used, the merchant processes the shopper's card at block 420 and the purchase is processed using the card checkout process at block 422. At block 414, the merchant is paid by card issuer payment system. In addition at block 424, the card issuer matches the purchase information with the referral information received from the search engine (block 410) and sends the results to the search engine. This allows the search engine to keep track and process referrals that led to purchases (i.e., search-to-purchase cases).

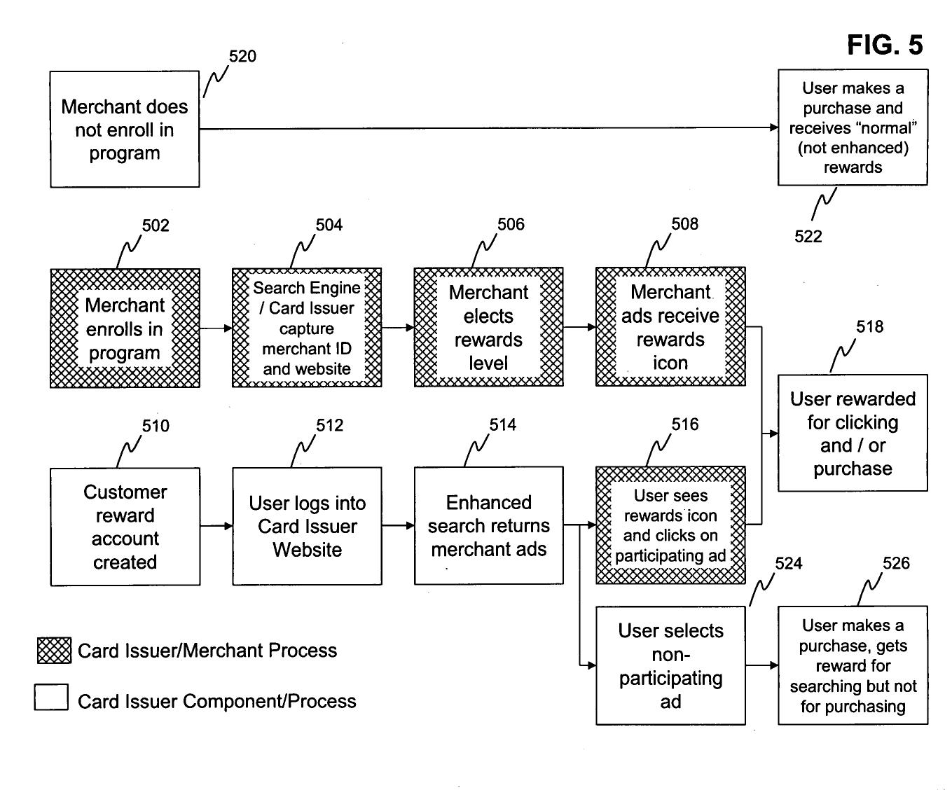

FIG. 5 illustrates an exemplary rewards enrollment process flow in accordance with an embodiment of the present invention. As shown at block 502, a merchant enrolls in a program which provides enhanced advertising and searching causing the search engine provider to issue a merchant identifier (“ID”). The search engine provider and card issuer capture a merchant ID created during the enrollment process as well as information about the merchant's website, as shown at block 504. The merchant, at block 506, elects a rewards level for purchases made from its business. Advertisements for the merchant are presented through the search engine. To indicate which offers provide loyalty rewards a rewards icon is displayed on the merchants advertisements.

Either concurrently with block 502 or before or after that block, a customer creates a reward account with the issuer or third party loyalty program, as shown in block 510. At block 512, a user logs into the card issuer website and performs a search at block 514 which presents the user with the advertisements associated with the merchant. As described above with respect to FIGS. 1-4, advertisements and search results are enhanced by using information provided by the card issuer which otherwise would not be available to the search engine provider. At block 516, a user may select advertisements which have a loyalty rewards icon which indicating that the user will receive a reward if a particular purchase is made. Advertisers may or may not participate in the enhanced search program. If a shopper selects an advertisement from a non-participating advertiser they may receive a reward for searching but not for making the purchase, as shown in blocks 524 and 526. At block 518, the user is rewarded for selecting the advertisement and/or making the purchase. A cardmember will receive the normal rewards associated with the use of their card, if any, from merchants who are not enrolled in the enhanced search program, as shown in blocks 520 and 522.

In an alternative embodiment, the rewards component may leverage advertiser systems (e.g., the merchants who are advertising their goods/services) without the participation of search engines, advertisement networks or publishers. In this embodiment, an advertiser can purchase rewards from a reward program (i.e., white label or otherwise) and issue rewards to consumers who have selected an associated advertisement and made a purchase.

For example, a merchant may advertise its products on a website. Subsequently, a user logs onto that website (or is recognized by alternative means, e.g., by use of cookies), selects the advertisement of the merchant, logs off (or exits the website), and purchases (either immediately or later) the advertised products either through the website or another website or physical store. In this example, the merchant issues rewards that it purchased from a rewards program processor.

The nature of the rewards depends upon the agreement forged between the rewards program processor and the advertiser and/or search engine, publisher, network, etc. In certain instances, the advertiser etc. may not have their own rewards currency, in which case it may purchase and issue rewards associated with a rewards program.

Another approach for when an advertiser etc. does not have its own rewards currency is for the rewards program processor to white label its own rewards program. In this case, the advertiser etc. outsources (at least in part) management of a rewards program to the rewards program processor, which can issue rewards on behalf of the advertiser. The rewards, while issued and managed by the rewards program processor, is branded as the rewards of the advertiser. For example, the rewards program processor manages and issues points associated with the retailer (e.g., “Acme Co Points” on behalf of the retailer.

Where the advertiser has its own rewards platform and currency, the benefits and/or capabilities of the rewards program processor are not needed. In this instance, the rewards program processor informs the advertiser that a purchase has been made in response to an advertisement and the advertiser would issue its own rewards through its own platform.

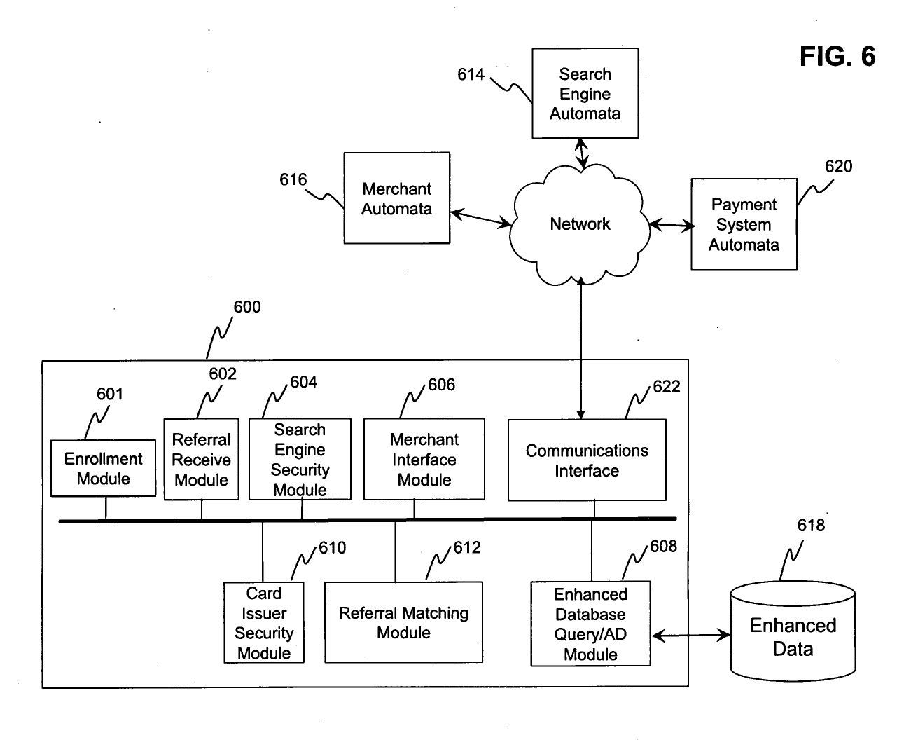

FIG. 6 is a block diagram of an interface unit 600 for integrating a search engine system and a card payment system. As shown in FIG. 6, a search engine automata 614, merchant automata 616 and payment system automata 620 are in communication with interface unit 600 via communications interface 622. Search engine automata 614 is control software or hardware located in the search engine that processes enhanced data received from the enhancement database 618 and transmits referrals to the card issuer via interface unit 600. Merchant automata 616 is control software or hardware located in the merchant site that controls transactions between the payment system and search engine provider or merchant. Payment system automata 620 is a software or hardware that controls the transactions between the payment system and the search engine provider, merchant or user.

Enrollment module 601 is provided to enroll card holders into the enhanced search program. Particularly, enrollment module 601 issues a card issuer ID to a user and communicates this ID to the search engine via communications interface 622 and search engine automata 614. A referral receive module 602 receives referral information from the search engine automata 614 based on selections made by a user using the search engine.

Search engine security module 604 provides security features to protect consumer's privacy and to provide secure searches. Particularly, referral receive module 602 may receive encrypted referral data including user information from a search engine and this information is decrypted and transformed within interface unit 600 by the search engine security module 604 to a format that can be read by the card issuer payment system automata 620 and used to retrieve information from enhanced database 618 via enhanced database query and advertisement module 608.

A card issuer security module 610 provides analogous security and formatting functions for the card issuer's payment system. Thus both the search engine and card issuer systems protect consumers privacy and inhibit attempts to illicitly obtain customer information. This also provides isolation between the search engine and the card issuer systems.

Enhanced database query module 608 formats referral information received from the search engine and performs a query on the enhanced database 618, which in turn returns enhanced search results and advertisements from enhanced database 618 via search engine automata 614 as described above. Matches found by the query terms are returned to the search engine for presentation to the user. Merchant interface module 606 provides payment and reconciliation procedures to a merchant via, for example merchant automata 616. Referral matches are processed by referral matching module 612 to provide reports to the search engine as to which online and offline searches resulted in a purchase due to referrals presented through the search engine. In turn, matches are processed by the search engine automata 614 to collect payment from the merchants for the referrals. A payment system automata 620 interfaces with the card issuer's payment system to accept payments from users and to reconcile payments with the merchant.

In another aspect of the present invention, information based on different levels of privacy is provided to the search engine. This allows the card issuer to communicate only information it has the user's permission to use. For example, the information may simply include a preference noted by the user during enrollment (e.g., baseball enthusiast). Enhanced data may also include non-personal aggregate information of thousands of card issuer members compiled based on characteristics or preferences similar to the user. The level of information used to enhance the search (e.g., from non-personal to personal information) can thus be controlled by the user.

In yet another aspect of the present invention, the user may be offered different levels of rewards based on the permissions it provides the card issuer. For example, the more information the user allows the card issuer to provide to the search engine, the more rewards it can receive since it is more likely the referral made through the search engine will be more closely tailored for the user.

As explained above, the present invention is not limited to interfacing card processors to search engines. Indeed, any entities that serve advertisements and online messages can benefit from the present invention.

In addition, any form of payment processing can be used and still be within the scope of the above embodiments. Instead of a card processor performing the transaction matching and referral described above, a processing system associated with an alternative payment form (or payment network, collectively referred to simply as “payment form”) performs the same functions through an alternative payment processor. Similarly, those skilled in the art will recognize that the payment processor can be a mobile payment processor, an electronic wallet and an electronic funds transfer processor as well. The loyalty processing steps are performed in the same manner as described above, but in accordance with the processing system being utilized.

The example embodiments of the invention may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU typically includes software resident on a storage media (e.g., a disk drive or memory card), which, when executed, directs the CPU in performing transmission and reception functions. The CPU software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application.

Software embodiments of the example embodiments presented herein may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the FIGS. 1-6 are presented for example purposes only. The architecture of the example embodiments presented herein is sufficiently flexible and configurable, such that it may be utilized (and navigated) in ways other than that shown in the accompanying figures. It is also to be understood that the procedures recited in the claims need not be performed in the order presented.

What is claimed is:

1. A network interface, comprising,
a referral receiver configured to receive a referral presented to a user;
a transaction communications processor configured to communicate data associated with a transaction to a payment processor; and
a referral matching module configured to match the referral with the transaction and communicate the match to a network associated with the referral.

2. The network interface according to claim 1, further comprising:
a reward communications processor configured to communicate a rewards amount to a rewards processor based on a referral match and the transaction.

3. The network interface according to claim 1, wherein the network associated with the referral is a network corresponding to at least one of a search engine, an advertisement network, a publisher network, the payment processor, and a rewards processor.

4. The network interface according to claim 1, wherein the payment processor is at least one of a card payment processor, a mobile payment processor, an alternative payment processor, an electronic wallet and an electronic funds transfer processor.

5. The network interface according to claim 1, wherein the payment processor is further configured to accept and process a payment based on a plurality of payment forms.

6. The network interface according to claim 1, further comprising:
a database processor configured to generate information targeted to the user based on at least one of (1) an account of the user corresponding to the network associated with the referral and (2) an account of the user corresponding to the payment processor,
wherein the information targeted to the user is communicated to the network associated with the referral for presentation to the user through an interface.

7. The network interface according to claim 1, further comprising:
a database operable to store data associated with at least one of a user and a search query input by the user, wherein the data is communicated to the network associated with the referral, and wherein the network associated with the referral engine is a search engine.

8. A computer-readable medium having stored thereon sequences of instructions, the sequences of instructions including instructions which when executed by a computer system causes the computer system to:
receive a referral presented to a user;
communicate data associated with a transaction to a payment processor; and
match the referral with the transaction and communicate the match to a network associated with the referral.

9. The computer-readable medium according to claim 8, further including a sequence of instructions which when executed by a computer system causes the computer system to:
communicate a rewards amount to a rewards processor based on a referral match and the transaction.

10. The computer-readable medium according to claim 8, wherein the network associated with the referral is a network corresponding to at least one of a search engine, an advertisement network, a publisher network, the payment processor, an electronic wallet and a rewards processor.

11. The computer-readable medium according to claim 8, wherein the payment processor is at least one of a card payment processor, a mobile payment processor, an alternative payment processor, an electronic wallet and an electronic funds transfer processor.

12. The computer-readable medium according to claim 8, wherein the payment processor is further configured to accept and process a payment based on a plurality of payment forms.

13. The computer-readable medium according to claim 8, further including a sequence of instructions which when executed by a computer system causes the computer system to:
generate information targeted to the user based on at least one of (1) an account of the user corresponding to the network associated with the referral and (2) an account of the user corresponding to the payment processor,
wherein the information targeted to the user is communicated to the network associated with the referral for presentation to the user through an interface.

14. The computer-readable medium according to claim 8, further including a sequence of instructions which when executed by a computer system causes the computer system to:
store data associated with at least one of a user and a search query input by the user; and
communicate the data to the network associated with the referral, and
wherein the network associated with the referral engine is a search engine.

15. A method for interfacing, comprising the steps of:
receiving a referral presented to a user;
communicating data associated with a transaction to a payment processor; and
matching the referral with the transaction and communicate the match to a network associated with the referral.

16. The method according to claim 15, further comprising the step of:
communicating, by the interface, a rewards amount to a rewards processor based on a referral match and the transaction.

17. The method according to claim 15, wherein the network associated with the referral is a network corresponding to at least one of a search engine, an advertisement network, a publisher network, the payment processor, and a rewards processor.

18. The method according to claim 15, wherein the payment processor is at least one of a card payment processor, a mobile payment processor, an alternative payment processor, an electronic wallet and an electronic funds transfer processor.

19. The method according to claim 15, wherein the payment processor is further configured to accept and process a payment based on a plurality of payment forms.

20. The method according to claim 15, further comprising the step of:
generating information targeted to the user based on at least one of (1) an account of the user corresponding to the network associated with the referral and (2) an account of the user corresponding to the payment processor,
wherein the information targeted to the user is communicated to the network associated with the referral for presentation to the user through an interface.

21. The method according to claim 15, further comprising the steps of:
storing data associated with at least one of a user and a search query input by the user; and
communicating the data to the network associated with the referral, and
wherein the network associated with the referral engine is a search engine.
